(19) United States
(12) Patent Application Publication
(10) Pub. No.: US 2017/0010126 A1
(43) Pub. Date: Jan. 12, 2017

(54) INERTIAL MEASUREMENT UNIT FOR ELECTRONIC DEVICES

(71) Applicants: Ke A. HAN, Shanghai (CN); Ke DING, Shanghai (CN); Rajasekaran ANDIAPPAN, Tampere, LS (FI); Liang LI, Shanghai (CN); Yong HU, Shanghai (CN); INTEL CORPORATION, Santa Clara, CA (US)

(72) Inventors: Ke Han, Shanghai (CN); Ke Ding, Shanghai (CN); Rajasekaran Andiappan, Ekenas (FI); Liang Li, Shanghai (CN); Yong Hu, Shanghai (CN)

(73) Assignee: Intel Corporation, Santa Clara, CA (US)

(21) Appl. No.: 15/119,251

(22) PCT Filed: Mar. 31, 2014
(86) PCT No.: PCT/CN2014/074342

§ 371 Date: Aug. 16, 2016

(51) Int. Cl. G01C 25/00; G01C 21/16

(52) U.S. Cl. CPC G01C 25/00; G01C 21/16

(57) ABSTRACT

In one example an inertial measurement unit comprises an autocalibration module to compute a covariance matrix from data received from a plurality of sensors, an adaptive weight control module to determine state-based feedback parameters for the gyroscope sensor, accelerometer sensor, and magnetometer sensor, and a sensor characteristic adjustment module to determine a modified covariance matrix based on an input from the adaptive weight control module. Other examples may be described.

### RELATED APPLICATIONS

The present application is a national stage application under 35 U.S.C. §371 of International Application No. PCT/CN2014/074342 filed on Mar. 31, 2014. Said Application No. PCT/CN2014/074342 is hereby incorporated herein by reference in its entirety.

### BACKGROUND

The subject matter described herein relates generally to the field of electronic devices and more particularly to an inertial measurement unit for electronic devices.

Electronic devices such as laptop computers, tablet computing devices, electronic readers, mobile phones, and the like may include location sensors such as global positioning sensors that can determine a location of the electronic device. Further such electronic devices may include sensors, e.g., accelerometers, gyroscopes, etc., for positioning, orientation, and motion detection. Techniques which enable an electronic device to process inputs from such sensors to approximate a position and/or orientation (i.e., attitude) of the electronic device may find utility.

### BRIEF DESCRIPTION OF THE DRAWINGS

The detailed description is described with reference to the accompanying figures.

FIG. 1 is a schematic illustration of an electronic device which may be adapted to implement an inertial measurement unit in accordance with some examples.

FIG. 2 is a high-level schematic illustration of an exemplary architecture to implement an inertial measurement unit in accordance with some examples.

FIG. 3 is a schematic illustration of components of an inertial measurement unit in accordance with some examples.

FIGS. 4A-4B are flowcharts illustrating operations in a method to implement an inertial measurement unit in accordance with some examples.

FIG. 5A includes graphs which illustrate a comparison in convergence rates between a conventional inertial measurement unit and an inertial measurement unit in accordance with some examples.

FIG. 5B includes graphs which illustrate a comparison in drift rates between a conventional inertial measurement unit and an inertial measurement unit in accordance with some examples.

FIGS. 6-10 are schematic illustrations of electronic devices which may be adapted to implement smart frame toggling in accordance with some examples.

### DETAILED DESCRIPTION

Described herein are exemplary systems and methods to implement an inertial measurement unit in electronic devices. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the particular examples.

As described above, it may be useful to provide electronic devices with an inertial measurement unit (IMU) which implements techniques to determine a location of the electronic device based on inputs from sensors such as an accelerometer, a magnetometer, and/or a gyroscope. The subject matter described herein addresses these and other issues by providing an inertial measurement unit which may be implemented in logic on one or more controller of the electronic device. In some examples, the inertial measurement unit utilizes feedback parameters which are adjusted adaptively in response to inputs from an accelerometer sensor and a magnetometer. The feedback parameters may be to adjust sensor characteristics such that the weight of the accelerometer input to the inertial measurement unit decreases as the output of the accelerometer increases. Similarly, the weight of the magnetometer input to the inertial measurement unit decreases as the output of the magnetometer increases. In some examples the weight of the gyroscope input to the inertial measurement unit decreases as the once the location algorithm implemented by the inertial measurement unit has converged.

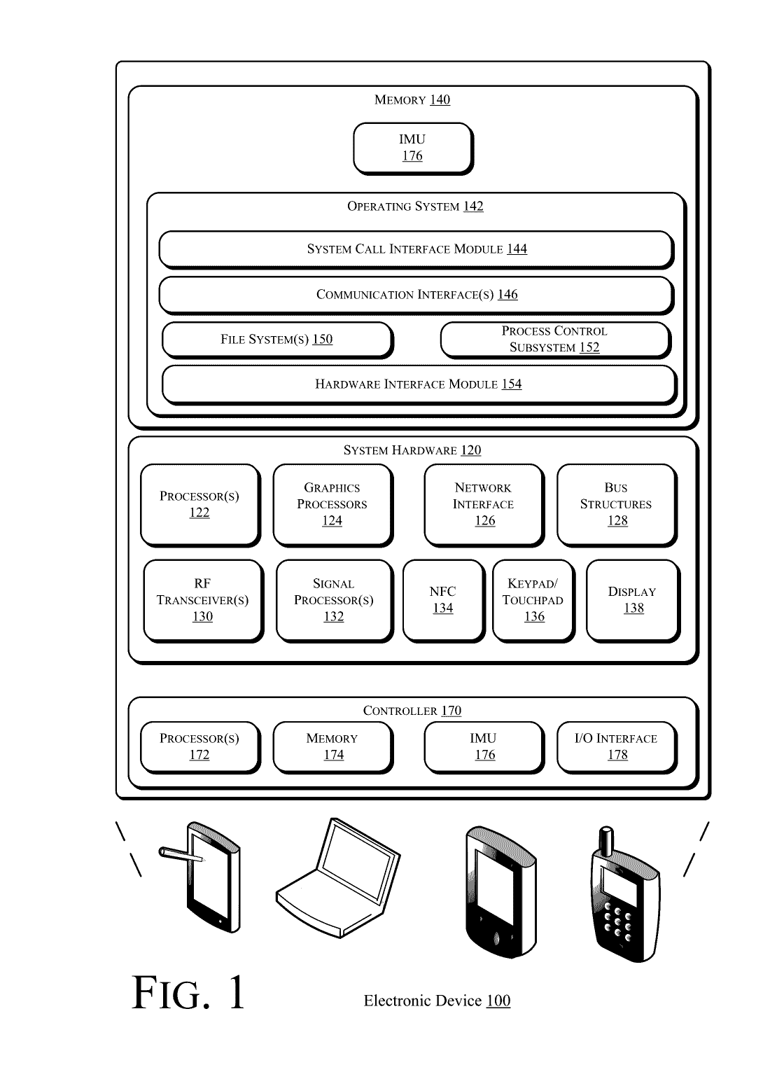

Additional features and operating characteristics of the inertial measurement unit and of electronic devices are described below with reference to FIGS. 1-10.

FIG. 1 is a schematic illustration of an electronic device 100 which may be adapted to implement an inertial measurement unit in accordance with some examples. In various examples, electronic device 100 may include or be coupled to one or more accompanying input/output devices including a display, one or more speakers, a keyboard, one or more other I/O device(s), a mouse, a camera, or the like. Other exemplary I/O device(s) may include a touch screen, a voice-activated input device, a track ball, a geolocation device, an accelerometer/gyroscope, biometric feature input devices, and any other device that allows the electronic device 100 to receive input from a user.

The electronic device 100 includes system hardware 120 and memory 140, which may be implemented as random access memory and/or read-only memory. A file store may be communicatively coupled to electronic device 100. The file store may be internal to electronic device 100 such as, e.g., eMMC, SSD, one or more hard drives, or other types of storage devices. Alternatively, the file store may also be external to electronic device 100 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel® Atom™ processors, Intel® Atom™ based System-on-a-Chip (SOC) or Intel ® Core2 Duo® or i3/i5/i7 series processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the motherboard of electronic device 100 or may be coupled via an expansion slot on the motherboard or may be located on the same die or same package as the Processing Unit.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN-Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI), a High Speed Synchronous Serial Interface (HSI), a Serial Low-power Inter-chip Media Bus (SLIMbus®), or the like.

Electronic device 100 may include an RF transceiver 130 to transceive RF signals, a Near Field Communication (NFC) radio 134, and a signal processing module 132 to process signals received by RF transceiver 130. RF transceiver may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN-Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a WCDMA, LTE, general packet radio service (GPRS) interface (see, e.g., Guidelines on GPRS Handset Requirements, Global System for Mobile Communications/GSM Association, Ver. 3.0.1, December 2002).

Electronic device 100 may further include one or more input/output interfaces such as, e.g., a keypad 136 and a display 138. In some examples electronic device 100 may not have a keypad and use the touch panel for input.

Memory 140 may include an operating system 142 for managing operations of electronic device 100. In one embodiment, operating system 142 includes a hardware interface module 154 that provides an interface to system hardware 120. In addition, operating system 140 may include a file system 150 that manages files used in the operation of electronic device 100 and a process control subsystem 152 that manages processes executing on electronic device 100.

Operating system 142 may include (or manage) one or more communication interfaces 146 that may operate in conjunction with system hardware 120 to transceive data packets and/or data streams from a remote source. Operating system 142 may further include a system call interface module 144 that provides an interface between the operating system 142 and one or more application modules resident in memory 130. Operating system 142 may be embodied as a UNIX operating system or any derivative thereof (e.g., Linux, Android, etc.) or as a Windows® brand operating system, or other operating systems.

In some examples an electronic device may include a controller 170, which may comprise one or more controllers that are separate from the primary execution environment. The separation may be physical in the sense that the controller may be implemented in controllers which are physically separate from the main processors. Alternatively, the trusted execution environment may logical in the sense that the controller may be hosted on same chip or chipset that hosts the main processors.

By way of example, in some examples the controller 170 may be implemented as an independent integrated circuit located on the motherboard of the electronic device 100, e.g., as a dedicated processor block on the same SOC die. In other examples the trusted execution engine may be implemented on a portion of the processor(s) 122 that is segregated from the rest of the processor(s) using hardware enforced mechanisms

In the embodiment depicted in FIG. 1 the controller 170 comprises a processor 172, a memory module 174, an inertial measurement unit 176, and an I/O interface 178. In some examples the memory module 174 may comprise a persistent flash memory module and the various functional modules may be implemented as logic instructions encoded in the persistent memory module, e.g., firmware or software. The I/O module 178 may comprise a serial I/O module or a parallel I/O module. Because the controller 170 is separate from the main processor(s) 122 and operating system 142, the controller 170 may be made secure, i.e., inaccessible to hackers who typically mount software attacks from the host processor 122. In some examples the inertial measurement unit 176 may reside in the memory 140 of electronic device 100 and may be executable on one or more of the processors 122.

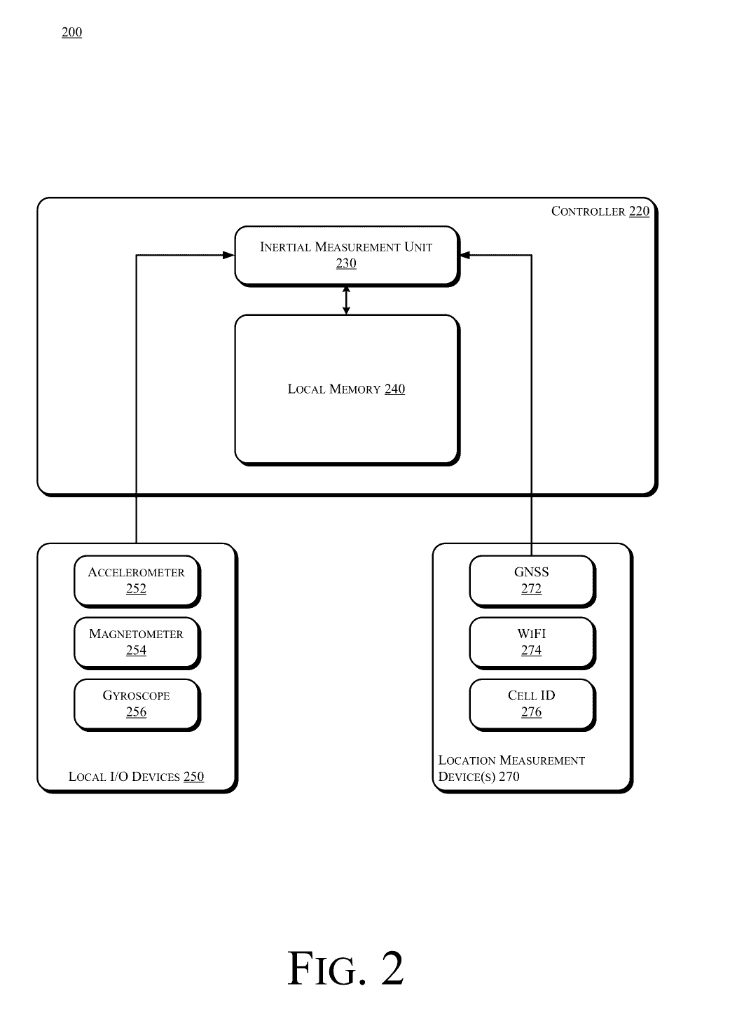

In some examples the an inertial measurement unit 176 interacts with one or more other components of the electronic device 100 to approximate a position of the electronic device. FIG. 2 is a high-level schematic illustration of an exemplary architecture 200 to implement smart frame toggling in electronic devices. Referring to FIG. 2, a controller 220 may be embodied as general purpose processor 122 or as a low-power controller such as controllers 170. Controller 220 may comprise a an inertial measurement unit 230 to manage smart frame operations and a local memory 240. As described above, in some examples the an inertial measurement unit 230 may be implemented as logic instructions executable on controller 220, e.g., as software or firmware, or may be reduced to hardwired logic circuits. Local memory 240 may be implemented using volatile and/or non-volatile memory.

Controller 220 may be communicatively coupled to one or more local devices input/output (I/O) devices 250 which provide signals that indicate whether an electronic device is in motion or other environmental conditions. For example, local I/O devices 250 may include an accelerometer 252, a magnetometer 254, and a gyroscope sensor 256.

Controller 220 may also be communicatively coupled to one or more location measurement devices 270, which may include a GNSS device 272, a WiFi device 274 and a cellular network device 276. GNSS device 272 may generate location measurements using a satellite network such as the Global Positioning System (GPS) or the like. WiFi device 274 may generate location measurements based on a location of a WiFi network access point. Similarly, Cell ID device may generate location measurements base on a location of a cellular network access point.

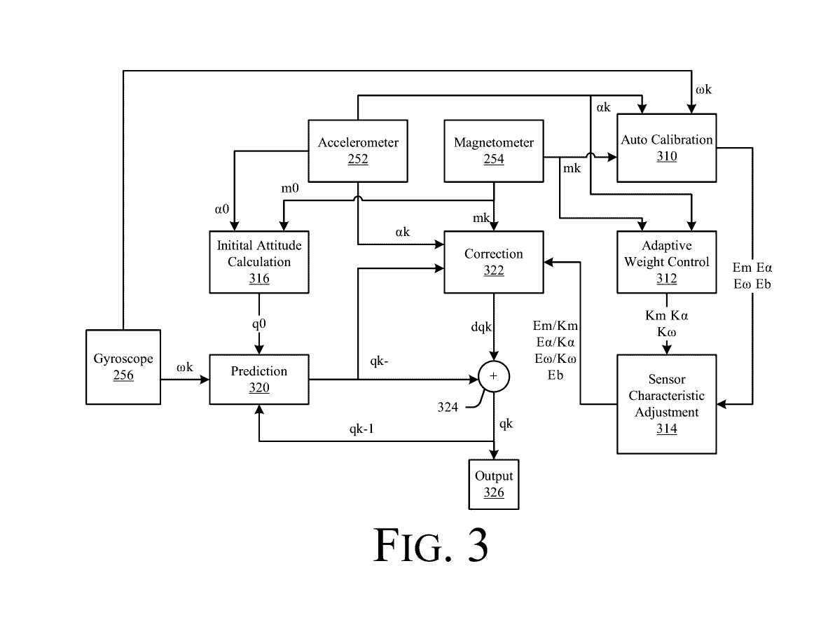

FIG. 3 is a schematic illustration of components of an inertial measurement unit such as inertial measurement unit 230 in accordance with some examples. Referring to FIG. 3, in some examples the inertial measurement unit 230 applies a prediction/correction model such as an extended Kalman filter (EKF) to approximate a location of the inertial measurement unit 230 based on outputs from an accelerometer 252, a magnetometer 254, and a gyroscope 256. A prediction unit 320 and a correction unit 322 form the core of the inertial measurement unit 230. In accordance with examples described herein, the EKF prediction/correction model is modified to incorporate an auto-calibration module 310, an adaptive weight control module 312, and a sensor characteristic adjustment module 314. Inertial measurement unit 230 further comprises an initial attitude calculation unit 316.

The output from the accelerometer 252 and the magnetometer 254 is input to an auto calibration unit 310 and to an initial attitude calculation module 316.

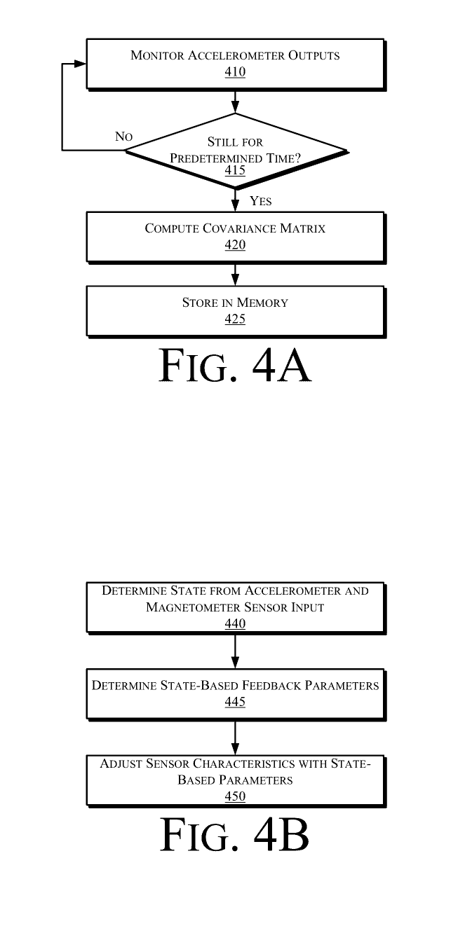

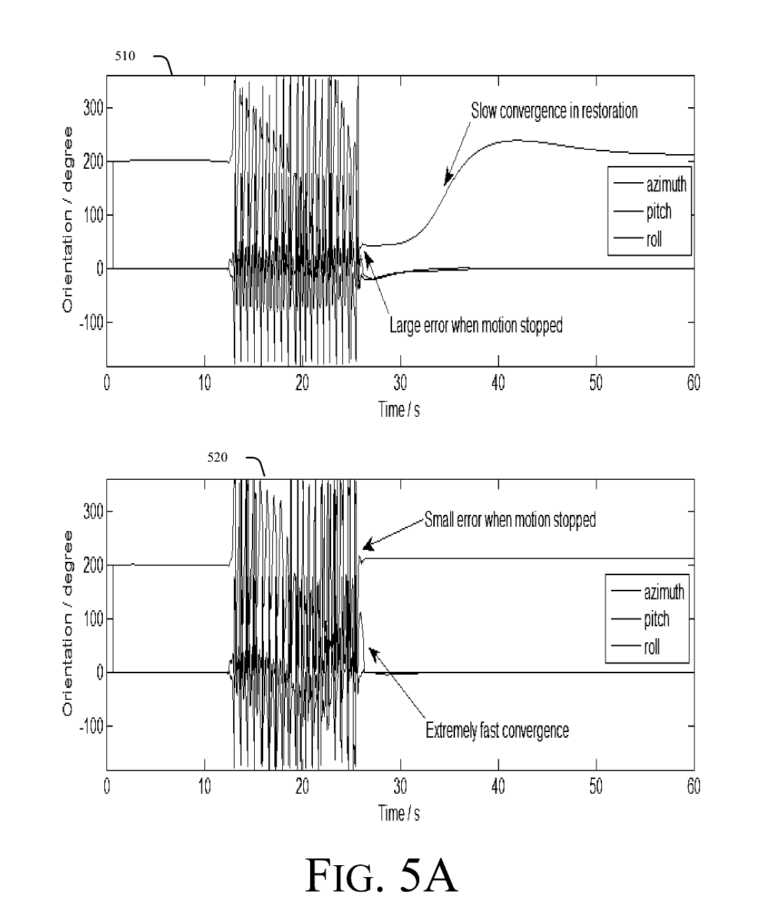

Having described various structures of a system to implement an inertial measurement unit in electronic devices, operating aspects of a system will be explained with reference to FIGS. 4A-4B, which are flowcharts illustrating operations in a method to implement an inertial measurement unit in accordance with some examples. The operations depicted in the flowcharts of FIGS. 4A-4B may be implemented by the an inertial measurement unit 230, alone or in combination with other component of electronic device 100.

In some examples the auto-calibration unit 310 of the inertial measurement unit 230 implements an auto-calibration process on a periodic basis when the inertial measurement unit 230 remains still for a predetermined period of time. Referring to FIG. 4A, at operation 410 the auto-calibration unit 320 monitors the output of the accelerometer 252. If, at operation 415, the accelerometer output indicates that the inertial measurement unit 230 did not remain still for a predetermined period of time then control passes back to operation 410 and the auto-calibration module continues to monitor the output of accelerometer 252. In some examples the predetermined period of time may be a fixed period of time (e.g., 1-2 milliseconds), while in other examples the period of time may be variable.

By contrast, if at operation remains still for the predetermined period of time then control passes to operation 420 and the auto-calibration unit 310 computes a covariance matrix. For example, the auto-calibration unit 310 may collect samples for a period of time and coumpute the covariance matrix Eₘ, E_{α}, E_{ω}, and E_{b}, where:

Eₘ is the magnetic measurement noise covariance matrix

E_{α} is the accelerometer measurement noise covariance matrix

E_{ω} is the gyroscope measurement noise covariance matrix.

E_{b} is the gyroscope bias drift measurement noise covariance matrix.

At operation 425 the covariance matrix computed in operation 410 is stored in memory, e.g., local memory 240.

With a covariance matrix is stored in memory 240, the inertial measurement unit 230 can implement a prediction-correction algorithm to approximate a location of the inertial measurement unit 230 based on outputs from the accelerometer 252, magnetometer 254, and gyroscope 256. Referring first to FIG. 3, in operation the output of the accelerometer 252 and the magnetometer 254 are provided as inputs to the initial attitude calculation unit 316, the auto-calibration unit 310, the adaptive weight control unit 312, and the correction unit 322. The output of gyroscope 256 is provided as an input to auto-calibration unit 310 and to prediction unit 320. The output of the initial attitude calculation unit 316 is provided to the prediction unit 320.

The output of the predication unit 320 is provided to the correction unit 322 and to a summer 324. The output of the correction unit 322 is provided to the summer 324, where it is combined with the output of the prediction unit 320 and provided as an output 326.

In accordance with examples described herein, the EKF prediction/correction model is modified to incorporate an auto-calibration module 310, an adaptive weight control module 312, and a sensor characteristic adjustment module 314. These modules enable the inertial measurement unit 230 to generate determine state-based feedback parameters, which may then be used to adjust sensor characteristics that are input to the correction unit 322.

Referring to FIG. 4B, at operation 440 the adaptive weight control module 312 determines three feedback parameters, Kₘ, K_{α}, and K_{ω}, where:

Kₘ is the feedback parameter for the magnetometer 254

K_{α} is the feedback parameter for the accelerometer 252.

K_{ω} is the feedback parameter for the gyroscope 256.

In some examples the feedback parameters K_{α}, Kₘ, K_{ω} are state-based parameters determined based on a state of the inertial measurement unit 230. The state of the inertial measurement unit 230 may be determined using a lookup table which assigns the state values as a function of the output of the accelerometer 252 and the magnetometer 254, as described in Table I.

TABLE I

| Sensor | State | Condition |
|---|---|---|
| Accelerometer | A1 (still) | accelerometer magnitude is within |
| | | 0.9~1.1 g |
| | A2 (light motion) | accelerometer magnitude is within |
| | | 0.7~0.9 g or 1.1~1.3 g |
| | A3 (high power | not A1 or A2 state |
| | motion) | |
| Magnetometer | M1 (stable | magnetometer magnitude is within |
| | environment) | 0.8*M~1.2*M |
| | M2 (unstable | Magnetometer magnitude is |
| | environment) | 0.7*M~0.9*M or 1.1*M~1.3*M |
| | M3 (bad | not M1 or M2 state |
| | environment) | |
| Init | Init (init state) | first 1 s in algorithm, or |
| | | first 1 s in A1M1 state |

In Table I: g represents the Earth's gravitational force, and M represents the Earth's magnetic field.

Once the accelerometer state (A1, A2, or A3) and the magnetometer state (M1, M2, or M3) are assigned control passes to operation 445 and the adaptive weight control unit 312 determines the feedback parameters K_{α}, Kₘ, K_{ω} based on the accelerometer state and the magnetometer state. In some examples the feedback parameters K_{α}, Kₘ, K₁₀₇ may be assigned using a lookup table indexed by the accelerometer state and the magnetometer state, as illustrated in FIG. 2.

TABLE II

| | M1 | M2 | M2 |
|---|---|---|---|
| A1 | Kₘ = 1, K_{α} = 1, | Kₘ = 0.25, K_{α} = 1, | Kₘ = 0.01, K_{α} = 1, |
| | K_{ω} = 1 | K_{ω} = 1 | K_{ω} = 1 |
| A2 | Kₘ = 1, K_{α} = 0.25, | Kₘ = 0.25, K_{α} = 0.25, | Kₘ = 0.01, K_{α} = 0.25, |
| | K_{ω} = 1 | K_{ω} = 1 | K_{ω} = 1 |
| A3 | Kₘ = 1, K_{α} = 0.01, | Kₘ = 0.25, K_{α} = 0.01, | Kₘ = 0.01, K_{α} = 0.1, |
| | K_{ω} = 1 | K_{ω} = 1 | K_{ω} = 1 |

| | |
|---|---|
| Init | Kₘ = 1, K_{α} = 1, K_{ω} = 0.001 |

Once the state-based parameters are assigned control passes to operation 450 and the sensor characteristics input to the correction module 322 are adjusted using on the state-base feedback parameters. In one example the sensor characteristic adjust module 314 determines a modified covariance matrix by which comprises Eₘ/, Kₘ, E_{α}/K_{α}, E₁₀₇ / K_{ω},and E_{b}. Thus, the adaptive weight control module decreases the weight of the state-based feedback of the accelerometer in response to an increase in the output of the accelerometer sensor. Similarly, the adaptive weight control module decreases the weight of the state-based feedback of the magnetometer in response to an increase in the output of the magnetometer sensor, and increases the weight of the state-based feedback to the gyroscope in response to a convergence in a prediction/correction algorithm.

The modified covariance matrix is then input to the sensor correction unit 322.

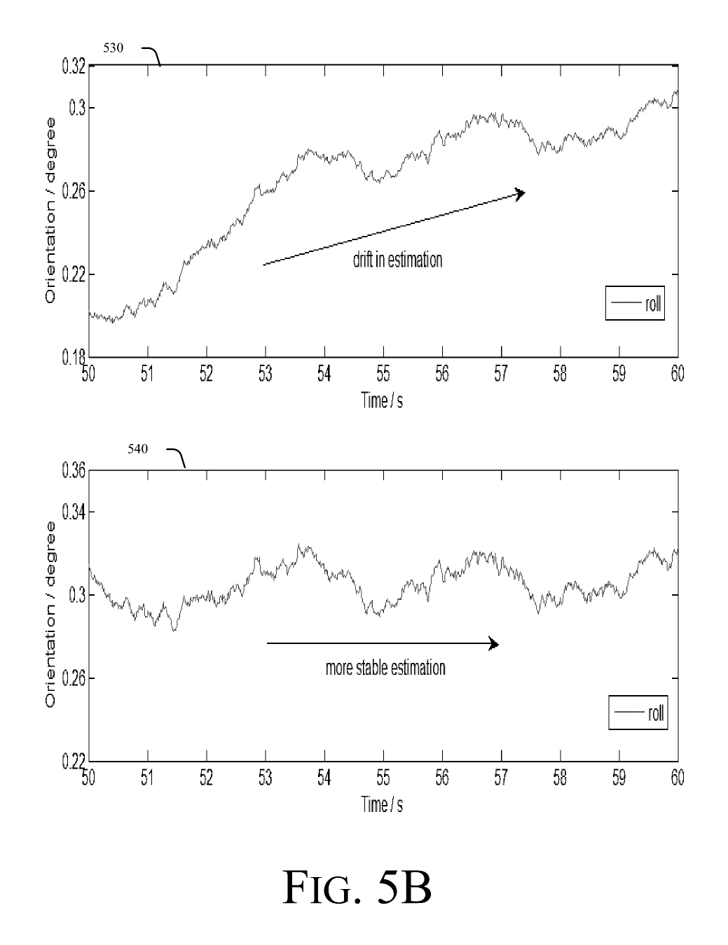

FIG. 5A includes graphs which illustrate a comparison in convergence rates between a conventional inertial measurement unit and an inertial measurement unit in accordance with some examples. Referring to FIG. 5A, the first graph 510 illustrates convergence rates and error for a conventional inertial measurement unit and the second graph 520 illustrates convergence rates and error for an inertial measurement unit which utilizes adaptive parameters in accordance with examples described herein. As illustrated in FIG. 5A, an inertial measurement unit which utilizes adaptive parameters converges more rapidly and with a lower error than a conventional inertial measurement unit.

FIG. 5B includes graphs which illustrate a comparison in drift rates between a conventional inertial measurement unit and an inertial measurement unit in accordance with some examples. Referring to FIG. 5B, the first graph 530 illustrates drift rates for a conventional inertial measurement unit and the second graph 540 illustrates drift rates for an inertial measurement unit which utilizes adaptive parameters in accordance with examples described herein. As illustrated in FIG. 5B, an inertial measurement unit which utilizes adaptive parameters exhibits a lower drift rate than a conventional inertial measurement unit.

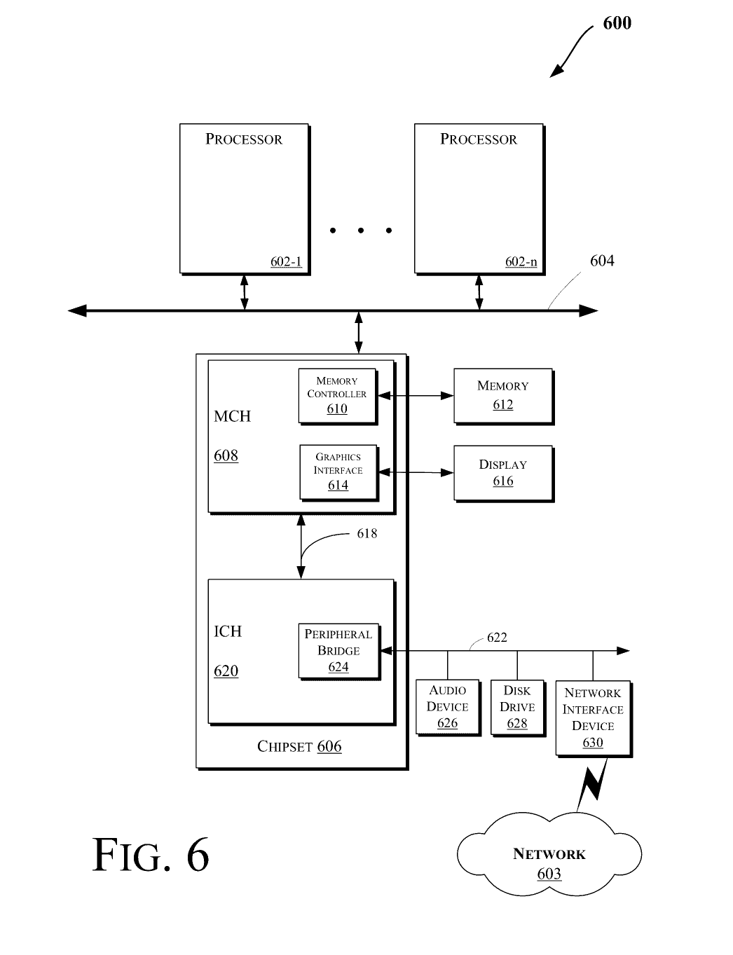

As described above, in some examples the electronic device may be embodied as a computer system. FIG. 6 illustrates a block diagram of a computing system 600 in accordance with an example. The computing system 600 may include one or more central processing unit(s) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an example, one or more of the processors 602 may be the same or similar to the processors 102 of FIG. 1. For example, one or more of the processors 602 may include the control unit 120 discussed with reference to FIGS. 1-3. Also, the operations discussed with reference to FIGS. 3-5 may be performed by one or more components of the system 600.

A chipset 606 may also communicate with the interconnection network 604. The chipset 606 may include a memory control hub (MCH) 608. The MCH 608 may include a memory controller 610 that communicates with a memory 612 (which may be the same or similar to the memory 130 of FIG. 1). The memory 412 may store data, including sequences of instructions, that may be executed by the processor 602, or any other device included in the computing system 600. In one example, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple processor(s) and/or multiple system memories.

The MCH 608 may also include a graphics interface 614 that communicates with a display device 616. In one example, the graphics interface 614 may communicate with the display device 616 via an accelerated graphics port (AGP). In an example, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the processor 602 and peripheral devices. Other types of topologies may be utilized. Also, multiple buses may communicate with the ICH 620, e.g., through multiple bridges or controllers. Moreover, other peripherals in communication with the ICH 620 may include, in various examples, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some examples. In addition, the processor 602 and one or more other components discussed herein may be combined to form a single chip (e.g., to provide a System on Chip (SOC)). Furthermore, the graphics accelerator 616 may be included within the MCH 608 in other examples.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

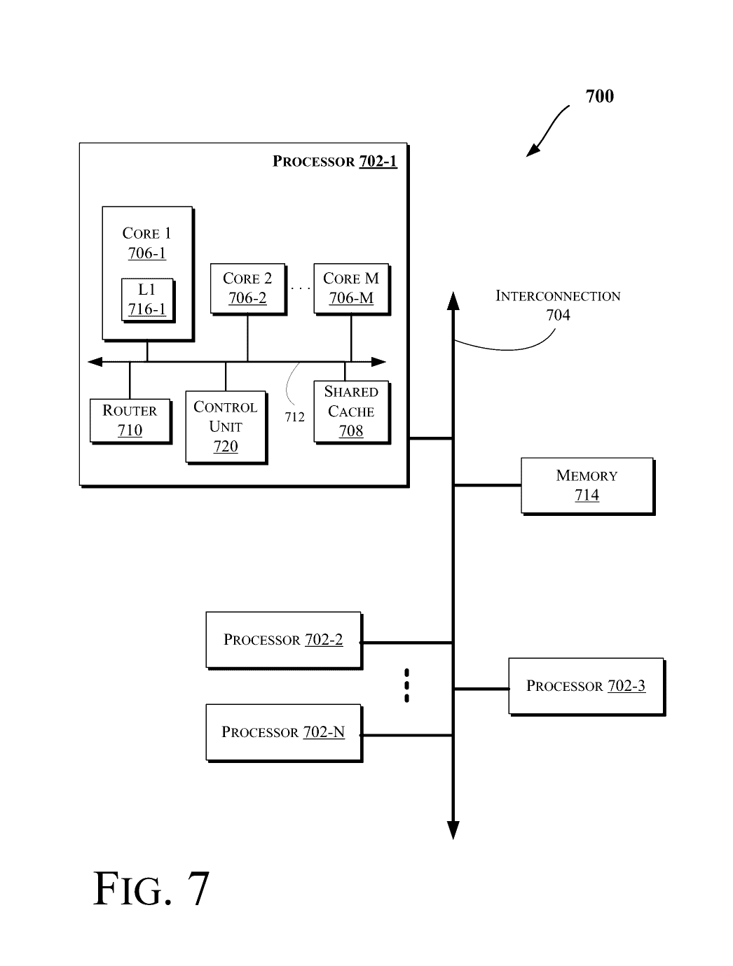

FIG. 7 illustrates a block diagram of a computing system 700, according to an example. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an example, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one example, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an example, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some examples, one or more of the cores 706 may include a level 1 (L1) cache 716-1 (generally referred to herein as “L1 cache 716”). In one example, the control unit 720 may include logic to implement the operations described above with reference to the memory controller 122 in FIG. 2.

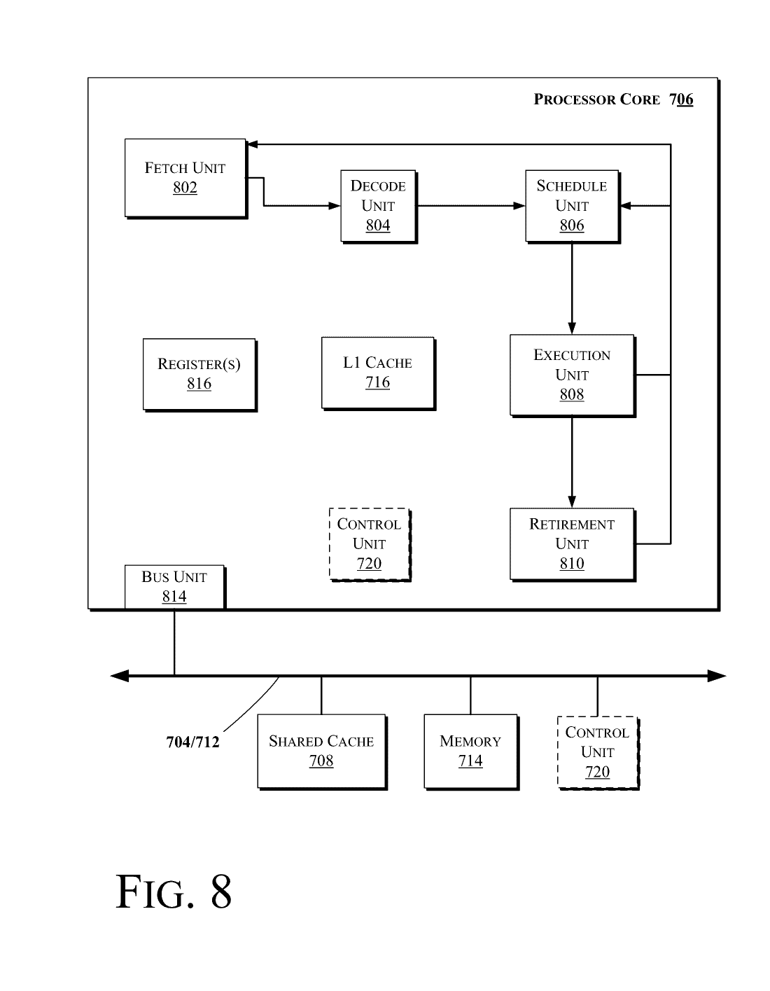

FIG. 8 illustrates a block diagram of portions of a processor core 706 and other components of a computing system, according to an example. In one example, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one example, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an example, the execution unit 808 may include more than one execution unit. The execution unit 808 may also perform various arithmetic operations such as addition, subtraction, multiplication, and/or division, and may include one or more an arithmetic logic units (ALUs). In an example, a co-processor (not shown) may perform various arithmetic operations in conjunction with the execution unit 808.

Further, the execution unit 808 may execute instructions out-of-order. Hence, the processor core 706 may be an out-of-order processor core in one example. The core 706 may also include a retirement unit 810. The retirement unit 810 may retire executed instructions after they are committed. In an example, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various examples the control unit 720 may be located elsewhere such as inside the core 706, coupled to the core via bus 704, etc.

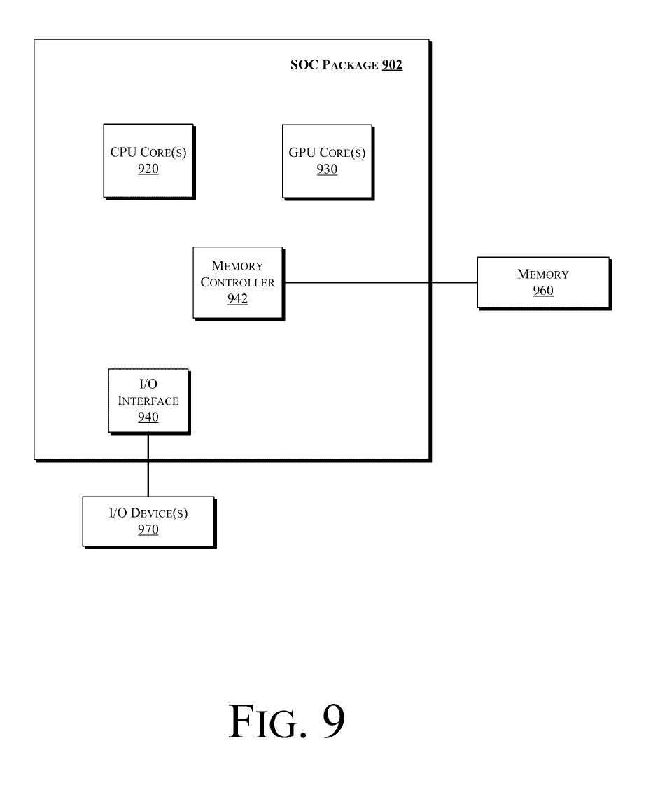

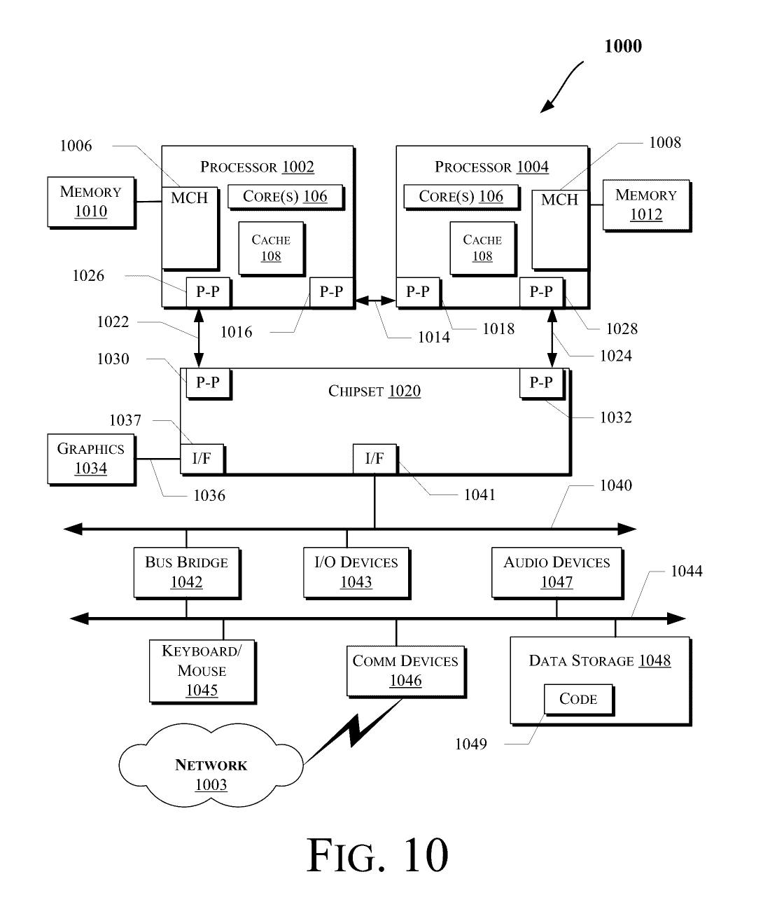

In some examples, one or more of the components discussed herein can be embodied as a System On Chip (SOC) device. FIG. 9 illustrates a block diagram of an SOC package in accordance with an example. As illustrated in FIG. 9, SOC 902 includes one or more processor cores 920, one or more graphics processor cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one example, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an example, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch surface, a speaker, or the like.

FIG. 10 illustrates a computing system 1000 that is arranged in a point-to-point (PtP) configuration, according to an example. In particular, FIG. 10 shows a system where processors, memory, and input/output devices are interconnected by a number of point-to-point interfaces. The operations discussed with reference to FIG. 2 may be performed by one or more components of the system 1000.

As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012. MCH 1006 and 1008 may include the memory controller 120 and/or logic 125 of FIG. 1 in some examples.

In an example, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

As shown in FIG. 10, one or more of the cores 106 and/or cache 108 of FIG. 1 may be located within the processors 1004. Other examples, however, may exist in other circuits, logic units, or devices within the system 1000 of FIG. 10. Furthermore, other examples may be distributed throughout several circuits, logic units, or devices illustrated in FIG. 10.

The chipset 1020 may communicate with a bus 1040 using a PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 1046 (such as modems, network interface devices, or other communication devices that may communicate with the computer network 1003), audio I/O device, and/or a data storage device 1048. The data storage device 1048 (which may be a hard disk drive or a NAND flash based solid state drive) may store code 1049 that may be executed by the processors 1004.

The following examples pertain to further examples.

Example 1 is an inertial measurement unit, comprising an autocalibration module to compute a covariance matrix from data received from a plurality of sensors, an adaptive weight control module to determine state-based feedback parameters for the gyroscope sensor, accelerometer sensor, and magnetometer sensor, and a sensor characteristic adjustment module to determine a modified covariance matrix based on an input from the adaptive weight control module.

In Example 2, the subject matter of Example 1 can optionally include an arrangement in which the plurality of sensors comrprises at least one of a gyroscope sensor, an accelerometer sensor, and a magnetometer sensor.

In Example 3, the subject matter of any one of Examples 1-2 can optionally include a prediction module and a correction module.

In Example 4, the subject matter of any one of Examples 1-3 can optionally include an arrangement in which the modified covariance matrix is input to the correction module.

In Example 5, the subject matter of any one of Examples 1-4 can optionally include an arrangement in which the autocalibration module comprises logic, at least partially including hardware logic, configured to monitor an output of the accelerometer sensor, and in response to a determination that the inertial measurement unit remained still for a predetermined period of time, to compute the covariance matrix.

In Example 6, the subject matter of any one of Examples 1-5 can optionally include an arrangement in which the autocalibration module comprises logic, at least partially including hardware logic, configured to determine a state based on an input from the accelerometer sensor and the magnetometer sensor and determine the state-based feedback parameters for the gyroscope sensor, accelerometer sensor, and magnetometer sensor based on the state.

In Example 7, the subject matter of any one of Examples 1-6 can optionally include an arrangement in which the adaptive weight control module decreases the weight of the state-based feedback of the accelerometer in response to an increase in the output of the accelerometer sensor.

In Example 8, the subject matter of any one of Examples 1-7 can optionally include an arrangement in which the adaptive weight control module decreases the weight of the state-based feedback of the magnetometer in response to an increase in the output of the magnetometer sensor.

In Example 9, the subject matter of any one of Examples 1-8 can optionally include an arrangement in which the adaptive weight control module increases the weight of the state-based feedback of the gyroscope in response to a convergence in a prediction/correction algorithm.

Example 10 is an electronic device, comprising at least one processor; and inertial measurement unit, comprising:inertial measurement unit, comprising an autocalibration module to compute a covariance matrix from data received from a plurality of sensors, an adaptive weight control module to determine state-based feedback parameters for the gyroscope sensor, accelerometer sensor, and magnetometer sensor, and a sensor characteristic adjustment module to determine a modified covariance matrix based on an input from the adaptive weight control module.

In Example 11, the subject matter of Example 10 can optionally include an arrangement in which the plurality of sensors comrprises at least one of a gyroscope sensor, an accelerometer sensor, and a magnetometer sensor.

In Example 12, the subject matter of any one of Examples 10-11 can optionally include a prediction module and a correction module.

In Example 13, the subject matter of any one of Examples 10-12 can optionally include an arrangement in which the modified covariance matrix is input to the correction module.

In Example 14, the subject matter of any one of Examples 10-13 can optionally include an arrangement in which the autocalibration module comprises logic, at least partially including hardware logic, configured to monitor an output of the accelerometer sensor, and in response to a determination that the inertial measurement unit remained still for a predetermined period of time, to compute the covariance matrix.

In Example 15, the subject matter of any one of Examples 10-14 can optionally include an arrangement in which the autocalibration module comprises logic, at least partially including hardware logic, configured to determine a state based on an input from the accelerometer sensor and the magnetometer sensor and determine the state-based feedback parameters for the gyroscope sensor, accelerometer sensor, and magnetometer sensor based on the state.

In Example 16, the subject matter of any one of Examples 10-15 can optionally include an arrangement in which the adaptive weight control module decreases the weight of the state-based feedback of the accelerometer in response to an increase in the output of the accelerometer sensor.

In Example 17, the subject matter of any one of Examples 10-16 can optionally include an arrangement in which the adaptive weight control module decreases the weight of the state-based feedback of the magnetometer in response to an increase in the output of the magnetometer sensor.

In Example 18, the subject matter of any one of Examples 10-17 can optionally include an arrangement in which the adaptive weight control module increases the weight of the state-based feedback of the gyroscope in response to a convergence in a prediction/correction algorithm.

Example 19 is a computer program product stored on a non-transitory computer readable medium which, when executed by a controller, configure the controller to implement an autocalibration module to compute a covariance matrix from data received from a plurality of sensors, an adaptive weight control module to determine state-based feedback parameters for the gyroscope sensor, accelerometer sensor, and magnetometer sensor, and a sensor characteristic adjustment module to determine a modified covariance matrix based on an input from the adaptive weight control module.

In Example 20, the subject matter of Example 19 can optionally include an arrangement in which the plurality of sensors comrprises at least one of a gyroscope sensor, an accelerometer sensor, and a magnetometer sensor.

In Example 21, the subject matter of any one of Examples 19-20 can optionally include a prediction module and a correction module.

In Example 22, the subject matter of any one of Examples 19-21 can optionally include an arrangement in which the modified covariance matrix is input to the correction module.

In Example 23, the subject matter of any one of Examples 19-22 can optionally include an arrangement in which the autocalibration module comprises logic, at least partially including hardware logic, configured to monitor an output of the accelerometer sensor, and in response to a determination that the inertial measurement unit remained still for a predetermined period of time, to compute the covariance matrix.

In Example 24, the subject matter of any one of Examples 19-23 can optionally include an arrangement in which the autocalibration module comprises logic, at least partially including hardware logic, configured to determine a state based on an input from the accelerometer sensor and the magnetometer sensor and determine the state-based feedback parameters for the gyroscope sensor, accelerometer sensor, and magnetometer sensor based on the state.

In Example 25, the subject matter of any one of Examples 19-24 can optionally include an arrangement in which the adaptive weight control module decreases the weight of the state-based feedback of the accelerometer in response to an increase in the output of the accelerometer sensor.

In Example 26, the subject matter of any one of Examples 19-25 can optionally include an arrangement in which the adaptive weight control module decreases the weight of the state-based feedback of the magnetometer in response to an increase in the output of the magnetometer sensor.

In Example 27, the subject matter of any one of Examples 19-26 can optionally include an arrangement in which the adaptive weight control module increases the weight of the state-based feedback of the gyroscope in response to a convergence in a prediction/correction algorithm.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An inertial measurement unit, comprising:
an autocalibration module to compute a covariance matrix from data received from a plurality of sensors;
an adaptive weight control module to determine state-based feedback parameters for the gyroscope sensor, accelerometer sensor, and magnetometer sensor; and
a sensor characteristic adjustment module to determine a modified covariance matrix based on an input from the adaptive weight control module.

2. The inertial measurement unit of claim 1, wherein the plurality of sensors comrprises at least one of a gyroscope sensor, an accelerometer sensor, and a magnetometer sensor.

3. The inertial measurement unit of claim 1, further comprising:
a prediction module; and
a correction module.

4. The inertial measurement unit of claim 3, wherein the modified covariance matrix is input to the correction module.

5. The inertial measurement unit of claim 2, wherein the autocalibration module comprises logic, at least partially including hardware logic, configured to:
monitor an output of the accelerometer sensor; and
in response to a determination that the inertial measurement unit remained still for a predetermined period of time, to compute the covariance matrix.

6. The inertial measurement unit of claim 2, wherein the autocalibration module comprises logic, at least partially including hardware logic, configured to:
determine a state based on an input from the accelerometer sensor and the magnetometer sensor; and
determine the state-based feedback parameters for the gyroscope sensor, accelerometer sensor, and magnetometer sensor based on the state.

7. The inertial measurement unit of claim 6, wherein the adaptive weight control module decreases the weight of the state-based feedback of the accelerometer in response to an increase in the output of the accelerometer sensor.

8. The inertial measurement unit of claim 6, wherein the adaptive weight control module decreases the weight of the state-based feedback of the magnetometer in response to an increase in the output of the magnetometer sensor.

9. The inertial measurement unit of claim 6, wherein the adaptive weight control module increases the weight of the state-based feedback of the gyroscope in response to a convergence in a prediction/correction algorithm.

10. An electronic device, comprising:
at least one processor; and
inertial measurement unit, comprising:
an autocalibration module to compute a covariance matrix from data received from a plurality of sensors;
an adaptive weight control module to determine state-based feedback parameters for the gyroscope sensor, accelerometer sensor, and magnetometer sensor; and
a sensor characteristic adjustment module to determine a modified covariance matrix based on an input from the adaptive weight control module.

11. The electronic device of claim 10, wherein the plurality of sensors comrprises at least one of a gyroscope sensor, an accelerometer sensor, and a magnetometer sensor.

12. The electronic device of claim 10, further comprising:
a prediction module; and
a correction module.

13. The electronic device of claim 11, wherein the modified covariance matrix is input to the correction module.

14. The electronic device of claim 10, wherein the autocalibration module comprises logic, at least partially including hardware logic, configured to:
monitor an output of the accelerometer sensor; and
in response to a determination that the inertial measurement unit remained still for a predetermined period of time, to compute the covariance matrix.

15. The electronic device of claim 10, wherein the autocalibration module comprises logic, at least partially including hardware logic, configured to:
determine a state based on an input from the accelerometer sensor and the magnetometer sensor; and
determine the state-based feedback parameters for the gyroscope sensor, accelerometer sensor, and magnetometer sensor based on the state.

16. The electronic device of claim 15, wherein the adaptive weight control module decreases the weight of the state-based feedback of the accelerometer in response to an increase in the output of the accelerometer sensor.

17. The electronic device of claim 15, wherein the adaptive weight control module decreases the weight of the state-based feedback of the magnetometer in response to an increase in the output of the magnetometer sensor.

18. The electronic device of claim 15, wherein the adaptive weight control module increases the weight of the state-based feedback of the gyroscope in response to a convergence in a prediction/correction algorithm.

19. A computer program product stored on a non-transitory computer readable medium which, when executed by a controller, configure the controller to implement:
an autocalibration module to compute a covariance matrix from data received from a plurality of sensors;
an adaptive weight control module to determine state-based feedback parameters for the gyroscope sensor, accelerometer sensor, and magnetometer sensor; and
a sensor characteristic adjustment module to determine a modified covariance matrix based on an input from the adaptive weight control module.

20. The computer program product of claim 19, wherein the plurality of sensors comrprises at least one of a gyroscope sensor, an accelerometer sensor, and a magnetometer sensor.

21. The computer program product of claim 19, further comprising:
a prediction module; and
a correction module.

22. The computer program product of claim 20, wherein the modified covariance matrix is input to the correction module.

23. The computer program product of claim 20, wherein the autocalibration module comprises logic, at least partially including hardware logic, configured to:
monitor an output of the accelerometer sensor; and
in response to a determination that the inertial measurement unit remained still for a predetermined period of time, to compute the covariance matrix.

24. The computer program product of claim 20, wherein the autocalibration module comprises logic, at least partially including hardware logic, configured to:
determine a state based on an input from the accelerometer sensor and the magnetometer sensor; and
determine the state-based feedback parameters for the gyroscope sensor, accelerometer sensor, and magnetometer sensor based on the state.

25. The computer program product of claim 24, wherein the adaptive weight control module decreases the weight of the state-based feedback of the accelerometer in response to an increase in the output of the accelerometer sensor.

26. The computer program product of claim 24, wherein the adaptive weight control module decreases the weight of the state-based feedback of the magnetometer in response to an increase in the output of the magnetometer sensor.

27. The computer program product of claim 21, wherein the adaptive weight control module increases the weight of the state-based feedback of the gyroscope in response to a convergence in a prediction/correction algorithm.
